(19) United States
(12) Patent Application Publication
(10) Pub. No.: US 2026/0010779 A1
(43) Pub. Date: Jan. 8, 2026

(54) MACHINE LEARNING MODEL FOR SPORTS EVENT DATA ANALYSIS

(71) Applicant: SAP SE, Walldorf (DE)

(72) Inventors: Hoang-Vu Nguyen, Leimen (DE); Michael Truong Ngoc, Frankfurt (DE); Anish Umesh, Heidelberg (DE)

(73) Assignee: SAP SE, Walldorf (DE)

(21) Appl. No.: 18/763,253

(22) Filed: Jul. 3, 2024

(51) Int. Cl. G06N 3/0499; G06N 3/045

(52) U.S. Cl. CPC G06N 3/0499; G06N 3/045

(57) ABSTRACT

A computer-implemented method can receive a sport event sequence including a plurality of events ordered sequentially, embed the plurality of events into a plurality of event vectors using an embedding stack, transform the plurality of event vectors into a plurality of encoded event vectors using an encoder stack, and train a machine learning model for predicting one or more subsequent events following a new sport event sequence. The training includes adjusting parameters of the embedding stack and the encoder stack based at least in part on the plurality of encoded event vectors. Related computing system and software are also disclosed.

### BACKGROUND

Sports analytics focus on analysis and interpretation of sports event data, which can be collected during sports. Each event can be characterized by multiple features such as start and end time, positions, involved players, event type, event outcome, etc. Existing methods for analyzing sports event data generally do not capture high-level latent patterns in the data and often oversimplify the complex dynamics of the events. They also struggle to accurately quantify the varying impact of different events on the outcome of the game. Thus, improvements to systems and methods for sports event data analysis are desirable.

### BRIEF DESCRIPTION OF THE DRAWINGS

FIG. 1 is an overall block diagram of an example computing system for intelligent sports event data analysis.

FIG. 2 is an example high-level architecture diagram of a machine learning model for sports event data analysis.

FIG. 3 is a flowchart illustrating an example overall method for intelligent sports event data analysis.

FIG. 4 depicts an example block diagram of an embedding stack that can be used in the machine learning model of FIG. 2.

FIG. 5 schematically illustrates a data embedding process that can be performed by the embedding stack of FIG. 4.

FIG. 6 depicts an example encoder stack that can be used in the machine learning model of FIG. 2.

FIG. 7 depicts an example self-attention mechanism that can be implemented in the encoder stack of FIG. 6.

FIG. 8 depicts an example multi-head attention mechanism that can be implemented in the encoder stack of FIG. 6.

FIG. 9 depicts an example inference stack that can be implemented in machine learning model of FIG. 2.

FIG. 10 depicts an example inference stack that can be used for fine-tuning the pre-trained machine learning model of FIG. 2 for a specific inference task.

FIG. 11 is a block diagram of an example computing system in which described technologies can be implemented.

FIG. 12 is a block diagram of an example cloud computing environment that can be used in conjunction with the technologies described herein.

### DETAILED DESCRIPTION

### Overview of Sports Event Data Analysis

Sports event data analysis is a complex task that involves the interpretation and analysis of event data collected during sports games or matches. Sports event data can be collected manually by trained operators, or automatically using advanced technologies such as sensor technology and/or image/video analysis of recorded games, or semi-automatically using a combination of manual input and automated systems.

Sports event data analysis often focuses on analyzing event sequences, each of which includes an ordered sequence of events that occur during a game. Each event can be represented as a data record with many features (or attributes), which can have different data types. These data types can be numerical (such as locations of a player, speed of movement, etc.), categorical (such as the event type, the player involved, the event outcome, etc.), or timestamps (such as the start and end time of an event).

For instance, in soccer, an event sequence might include a pass, followed by a dribble, and then a shot on goal. These events can have a fixed set with mixed data type. For example, each event can have a start and end time (e.g., represented in timestamp data type), start and end positions on the field (e.g., two dimensional coordinates represented in numerical data type), player involved (e.g., players' name or jersey number represented in categorical data type), event type (e.g., pass, dribble, tackle, shot, etc., represented in categorical data type), event outcome (e.g., goal, no goal, successful tackle, foul, etc., represented in categorical data type), and so on.

Analysis of event sequence is also applicable to other team sports like basketball, volleyball, etc. For example, an event sequence in a volleyball game could include events like serves, shots, blocks, etc. These events could have a set of features specific to volleyball such as the player involved, the type of serve or shot, the position on the court, the trajectory and speed of the ball, the outcome of the events, or the like. Similar concept can also extend to non-team sports such as golf, tennis, etc. For example, an event sequence in a tennis game could include events like serves, returns, volleys, smashes, etc. These events would have its own set of features, such as the type of stroke, the position on the court, the speed and spin of the ball, the outcome of the events, or the like.

Existing methods for sports event data analysis often struggle to capture high-level latent patterns in the event data, and they tend to oversimplify the intricate dynamics of the events. This oversimplification often leads to inaccurate quantification of the varying impact of different events on the outcome of the games.

For example, one conventional approach for analyzing a sport event sequence is to quantify the impact of each event towards an event outcome (e.g., scoring a goal, etc.). This is typically done by constructing the features for every event by combining its raw features with the raw features of its preceding events. However, this approach presents at least two significant technical challenges. First, the features are merely raw representations, meaning they do not capture high-level latent patterns in the data. These latent patterns may provide valuable insights into the dynamics of the game and the performance of the players, but they remain untapped with the existing methods. Second, existing approaches generally flatten the event data, assuming all previous events to have equal impact on the current event. This is often not the case in sports games, where the impact of an event can be influenced by a variety of factors, including the sequence and context of the preceding events.

For instance, in soccer, a pass followed by a dribble and then a shot on goal is a common event sequence. However, the impact of the pass on the shot on goal is not necessarily the same as the impact of the dribble. Similarly, the impact of a pass might be different in different contexts, such as the position on the field, the player involved, etc. This complexity extends to other sports as well. Regardless of the sports, the sequence and context of events can significantly influence their impact on the game.

The technologies described herein address many of the challenges noted above by utilizing a machine learning (ML) model for intelligent sports event data analysis. As described more fully below, the ML model can be trained to capture high-level latent patterns in the data and accurately reflect the diverse impacts of different events. As such, the ML model provides a more nuanced and accurate analysis of sports event data, representing technological advancements in the field of sports analytics.

### Example Computing System for Intelligent Sports Event Data Analysis

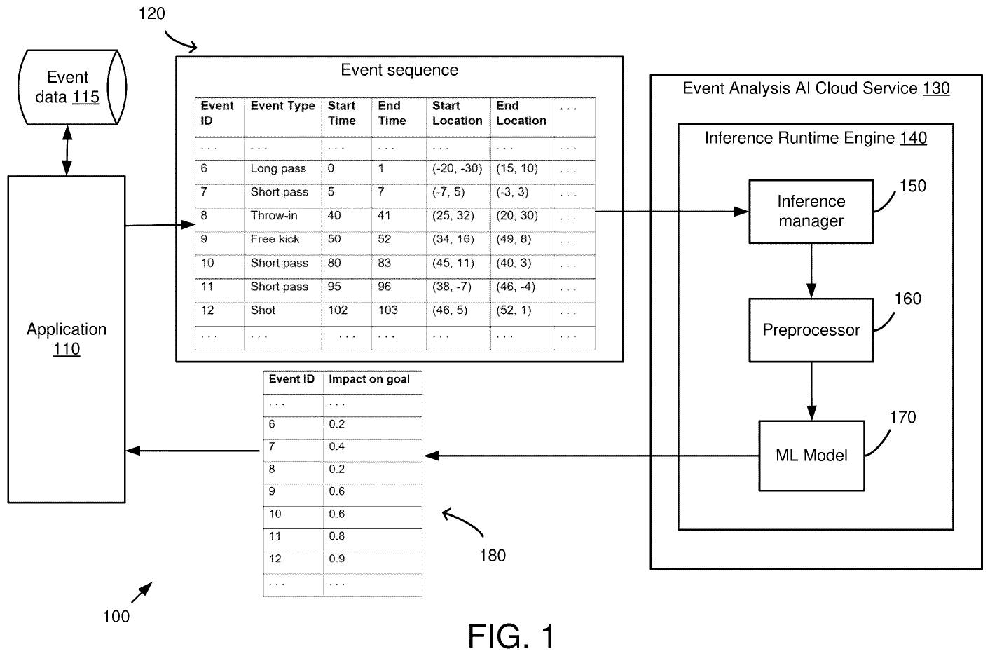

FIG. 1 shows an overall block diagram of an example computing system 100 supporting intelligent sports event data analysis. Although soccer events are depicted in FIG. 1 as examples, it should be understood that the computing system 100 can be used for intelligent event analysis of other sports.

As shown in FIG. 1, the computing system 100 includes a front-end software application 110 through which a user can interact with and an event analysis artificial intelligence (AI) cloud service 130 operating in the backend.

In some examples, the software application 110 can run on the cloud. In some examples, the software application 110 can be installed on premise. In some examples, multiple software applications 110 can run simultaneously. This can be achieved, e.g., through the use of virtualization technologies that allow the creation of virtual machines or containers. Each of these virtual environments can host a separate instance of the software application 110, allowing multiple users to interact with the software application 110 independently and concurrently. In a cloud environment, these virtual environments can be hosted on shared physical servers, maximizing resource utilization and scalability. For on premise installations, dedicated hardware can be used for each virtual environment.

The software application 110 can access raw event data 115 collected during sport games. Utilizing the software application 110, users can transmit an inference request to the event analysis AI cloud service 130. The inference request can include an event sequence 120 extracted from the raw event data 115. The event sequence 120 can include a plurality of events arranged in a tabular format. For example, each event can be represented as a distinct row or record in the table, while the columns of the table can represent different features (or attributes, fields, characteristics) of the events. The events within the event sequence 120 can be organized sequentially, such as in ascending order from the game's start time. As illustrated in FIG. 1, the event sequence 120 includes a sequence of events recorded during a soccer game. Each event has a plurality of features, including an event identifier (ID), event type, start time, end time, start location, end location, among others. In other examples, the event sequence 120 can be represented in other formats (e.g., JSON objects, etc.).

The event analysis AI cloud service 130 includes an inference runtime engine 140 configured to receive inference requests submitted by the users, and produce, in runtime or with negligible delay, analytical results 180 based on the event sequences 120 provided. The analytical results 180 can provide valuable insights and predictions about the events, thereby enabling users to make informed decisions or strategies based on the analyzed data. In some examples, the analytical results 180 can include statistical measures indicating the expected effect or contribution of each event in the event sequence on the game's outcome. For example, the analytical results 180 illustrated in FIG. 1 the impact on goal of multiple events in a soccer game (e.g., the “shot” event (with an event ID=12) has a 90% probability of leading to a goal, etc.). In other examples, the analytical results 180 can include predictive outcomes, e.g., whether there is a goal within the next K events (where K is a user defined integer) following the current event sequence 120. These analytical results 180 can then be returned to the users for further interpretation and application.

The inference runtime engine 140 can include an inference manager 150, a preprocessor 160, and a trained ML model 170. The inference manager 150 is configured to receive to handle multiple inference requests submitted by users. This can be achieved through parallel processing of multiple instances, ensuring efficient and timely processing of user requests. The preprocessor 160 is configured to perform error handling or sanity checks on the request payload, such as the event sequence 120. For example, the preprocessor 160 can check for the presence of any extra or irrelevant fields, removes redundant data, and/or converts the data into the proper format required for further processing. The ML model 170 can be a pre-trained AI/ML model that is fine tuned to perform inference based on the event sequence 120. It processes the preprocessed data to generate analytical results 180. Detailed architecture of the ML model 170 and methods for training the ML model 170 are described more fully below.

In practice, the systems shown herein, such as the computing system 100, can vary in complexity, with additional functionality, more complex components, and the like. For example, there can be additional functionality within the inference runtime engine 140. Additional components can be included to implement security, redundancy, load balancing, report design, data logging, and the like.

The described computing systems can be networked via wired or wireless network connections, including the Internet. Alternatively, systems can be connected through an intranet connection (e.g., in a corporate environment, government environment, or the like).

The computing system 100 and any of the other systems described herein can be implemented in conjunction with any of the hardware components described herein, such as the computing systems described below (e.g., processing units, memory, and the like). In any of the examples herein, configuration keys, data objects, prompts, tables, and the like can be stored in one or more computer-readable storage media or computer-readable storage devices. The technologies described herein can be generic to the specifics of operating systems or hardware and can be applied in any variety of environments to take advantage of the described features.

### Example Architecture of ML Model for Intelligent Sport Event Data Analysis

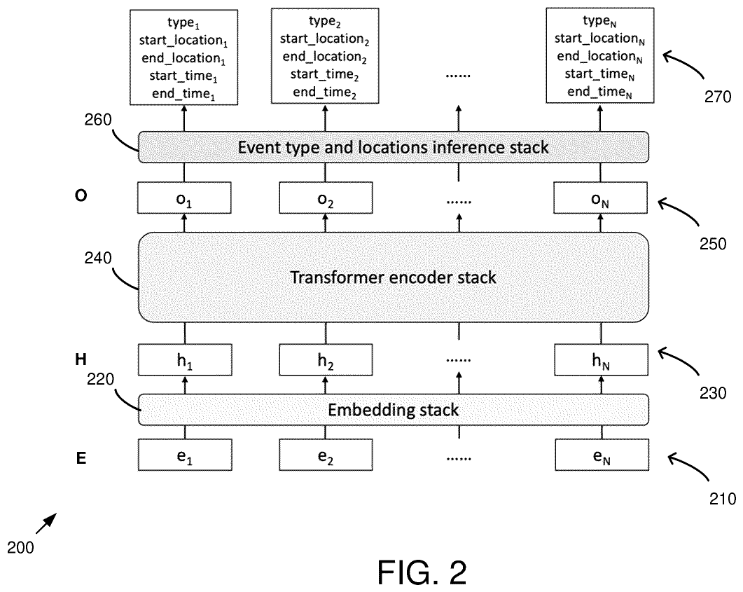

FIG. 2 shows an example architecture of a ML model 200, which can be used in the ML model 170 of FIG. 1.

The ML model 200 includes an embedding stack 220 configured to convert a plurality of events 210 in an event sequence (e.g., the event sequence 120) into corresponding event vectors 230. As described herein, embedding is a process that transforms event data into a high-dimensional vector space where similar event data are closer together, enabling more efficient and meaningful computations. For example, FIG. 2 shows an event sequence E including N events e₁, e₂, . . . , e_{N}, i.e., E={e₁, e₂, . . . , e_{N}}. The output of the embedding stack 220 is a plurality of embedded event vectors 230, denoted as h₁, h₂, . . . , h_{N}, or collectively H, i.e., H={h₁, h₂, . . . , h_{N}}.

As described herein, each event includes a plurality of features. For example, eᵢ={ƒ_{i,1}, ƒ_{i,2}, . . . , ƒ_{i,L}}, where ƒ_{i,j} denotes the j-th feature of the i-th event eᵢ, and L is a positive integer representing the number of features in the event. The features can have mixed data types. For example, some features can have a numerical data type (e.g., start and end locations of a player, etc.), some features can have a categorical data type (e.g., event type, etc.), and some features can have a timestamp data type (e.g., start and end times of an event, etc.). As described further below, the embedding stack 220 can be configured to apply different embedding schemes for features with different data types.

The ML model 200 further includes an encoder stack 240 configured to transform the plurality of event vectors 230 corresponding encoded event vectors 250, denoted as o₁, o₂, . . . , o_{N}, or collectively O, i.e, O={o₁, o₂, . . . , o_{N}}. As described further below, the encoder stack 240 includes at least one encoder layer which is configured to apply a self-attention mechanism to the plurality of event vectors 230. The self-attention mechanism is a component of transformer models such as the generative pre-trained transformer (GPT) developed by OpenAI, etc. The self-attention mechanism allows the ML model 200 to weigh the importance of each event in the event sequence when encoding a particular event. This can be achieved, e.g., by calculating a score for each event, indicating how much attention should be paid to that event when encoding the current event. The self-attention mechanism enables the ML model 200 to capture long-range dependencies between events in the event sequence.

The encoder stack 240 yields the encoded event vectors 250 as its output. These vectors are high-dimensional representations that adeptly capture the intricate relationships and contextual nuances within the event sequence. More specifically, the encoded event vectors 250 encapsulate not only the interdependencies among the events but also their temporal dynamics, thereby revealing latent patterns that might not be immediately apparent.

The encoded event vectors 250 provide a rich, context-aware representation that can be used for downstream tasks such as prediction, classification, etc. For example, the ML model 200 can include an additional inference stack 260 configured to predict selected features 270 of the events (e.g., event type, start and end locations, start and end times, etc.) based on the encoded event vectors 250. Such event feature prediction can be one of several pre-training tasks of the ML model 200. Once pre-trained, the ML model 200 can be fine-tuned for specific tasks by replacing the inference stack 260 with a different inference stack tailored to that task. This allows the ML model 200 to leverage the rich representations learned during pre-training while adapting its final layers to the specificities of the task at hand, thereby enhancing its performance and adaptability.

The ML model 200, as described above, shares similarities with the Bidirectional Encoder Representations from Transformers (BERT) model, particularly in its use of embeddings and self-attention mechanisms. However, unlike BERT which is traditionally applied to text data (sequence of tokens), the ML model 200 is configured to handle sports event data with mixed data types. Moreover, while text data is synchronous with tokens appearing at regular intervals, sports event data is asynchronous, with events occurring at different points in time. This necessitates the use of time-aware embeddings to capture the temporal dynamics of the events. Thus, the ML model 200 can be viewed as an adaptation of the BERT model, fine-tuned to handle the specific characteristics and challenges of sports event data.

Additional details of the embedding stack 220, encoder stack 240, and inference stack 260 are described further below.

### Example Overall Method for Intelligent Sports Event Data Analysis

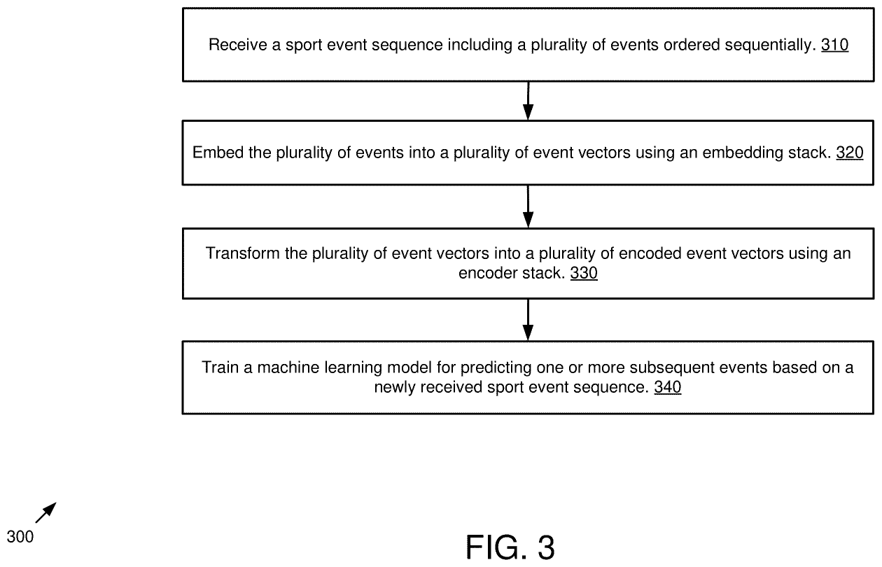

FIG. 3 is a flowchart illustrating an example overall method 300 for intelligent sports event data analysis. The method 300 can be performed, e.g., by the computing system 100 depicted in FIG. 1.

At step 310, the method can receive a sport event sequence including a plurality of events (e.g., the events 210) ordered sequentially. The events can have a plurality of features with mixed data types such as numerical data type (also referred to as “numerical features”), categorical data type (also referred to as “categorical features”), timestamp data type (also referred to as “timestamp features”), etc.

As described herein, the numerical data type refers to quantitative data representing measurements or counts. Numerical data types can be represented in different subtypes such as integer, float, double, etc. Categorical data type refers to qualitative data representing characteristics or descriptors. Categorical data type can also have different representations such as Boolean (e.g., true or false), strings or data values enumerated in a fixed data set (e.g., a fixed number of categories or groups). Timestamp data type represents to a specific instance in time (e.g., hh:mm:ss).

At step 320, the method can embed the plurality of events into a plurality of event vectors (e.g., the event vectors 230) using an embedding stack (e.g., the embedding stack 220). The embedding stack is configured to apply different embedding schemes for features with different data types.

At step 330, the method can transform the plurality of event vectors into a plurality of encoded event vectors (e.g., the encoded event vectors 250) using an encoder stack (e.g., the encoder stack 240). The encoder stack includes at least one encoder layer which is configured to apply a self-attention mechanism to the plurality of event vectors.

At step 340, the method can train a ML model (e.g., the ML model 200) for predicting one or more subsequent events following a new sport event sequence. The training includes adjusting parameters of the embedding stack and the encoder stack based at least in part on the plurality of encoded event vectors. Additional details of the training process are described further below.

The method 300 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example Embedding Stack

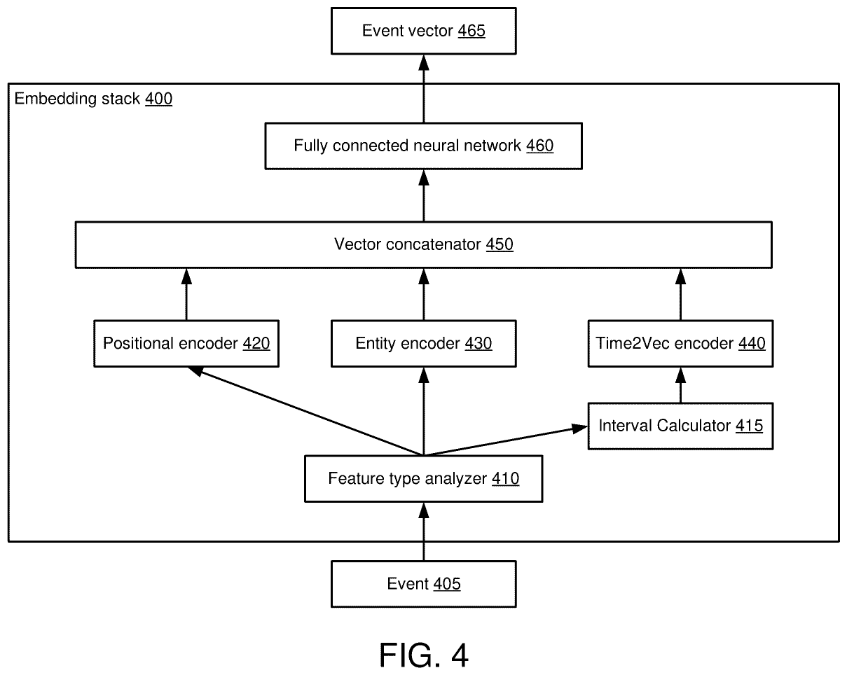

FIG. 4 shows the block diagram of an example embedding stack 400, which can be an embodiment of the embedding stack 220 of FIG. 2. The embedding stack 400 is configured to convert each event 405 (in an event sequence), which can have features of mixed data types, into a corresponding event vector 465.

The embedding stack 400 includes a feature type analyzer 410 configured to detect different feature types in the event 405. Depending on the detected feature types, individual features of the event 405 can be encoded into corresponding feature vectors using different embedding schemes. For example, each numerical feature can be embedded into a corresponding feature vector using a positional encoder 420, and each categorical feature can be embedded into a corresponding feature vector using an entity encoder 430. Each numerical feature can be first converted into a time difference value by an interval calculator 415 (e.g., calculating a difference between the timestamp of the current event and the timestamp of a starting event such as the first event in the event sequence), and then the time difference value can be embedded into a corresponding feature vector using a Time2Vec encoder 440. Collectively, the positional encoder 420, entity encoder 430, and Time2Vec encoder 440 represent an embedding layer.

The positional encoder 420 can be configured to encode numerical features using a positional embedding scheme. In particular, each numerical value x can be embedded into a feature vector v of dimensions dₙ. In some examples, dₙ can be an even integer. In other examples, dₙ can be an odd integer. For each i∈[1, dₙ], the i-th element of the feature vector v, or v[i], can be calculated as the sine of

$$x / {M}^{\frac{i}{{d}_{n}}}$$

if i is even, and the cosine of

$$x / {M}^{\frac{i}{{d}_{n}}}$$

otherwise. Here, dₙ and M are hyperparameters learned (e.g., through training) to reasonably fit all numeric features.

The entity encoder 430 can be configured to encode categorical features using an entity encoding scheme. Specifically, each categorical value can be initially represented by a random feature vector (e.g., with a predefined dimension dc). As the model learns from the data during the training process, these feature vectors can be iteratively updated. The updating process is similar to how weights are updated in a neural network (NN), e.g., using methods such as gradient descent, with the goal of adjusting the feature vectors in a way that reduces the prediction error of the model. Over time, this process results in feature vectors that meaningfully represent the categories, with similar categories having feature vectors that are close to each other in the embedding space. For instance, if a categorical feature has 10 distinct categorical values, then 10 feature vectors are learned, one for each category.

The Time2Vec encoder 440 can be configured to encode timestamp features using a Time2Vec embedding scheme, which can transform time-related features into a multi-dimensional vector space. More specifically, each timestamp feature ƒ_{i,j} is first converted into a real value by calculating its difference t with a reference timestamp, e.g., t=ƒ_{i,j}−ƒ_{i,1}, where ƒ_{i,1} is the timestamp of the first event in the event sequence. Then, Time2Vec embedding is used to learn a multi-dimensional feature vector for the real-valued ƒ_{i,j}. For example, each time difference value t can be represented as a feature vector w of dₜ dimensions, where the i-th element of the feature vector w, or w[i], can be calculated as αᵢ·t+βᵢ if i=0, and F(αᵢ·t+βᵢ) if 1≤i≤dₜ. Here, αᵢ and βᵢ are trainable weights and F is a periodic function such as the sine function.

The feature vectors generated by the positional encoder 420, entity encoder 430, and Time2Vec encoder 440 can be concatenated by a vector concatenator 450. The vector concatenator 450 combines the feature vectors generated by the different embedding schemes into a single composite feature vector, thereby creating a comprehensive representation of each event that captures all its features across different data types.

In some examples, the embedding stack 400 can further include a fully connected neural network 460 configured to convert the composite feature vector (i.e., output of the vector concatenator 450) into the event vector 465. A fully connected neural network is a type of artificial neural network where each neuron in one layer is connected to every neuron in the next layer, allowing for complex and deep representations of the input data. The fully connected neural network 460 can be configured to implement a dimensionality reduction scheme so that the event vector 465 has a lower dimension than the composite feature vector generated by the vector concatenator 450. Such dimensionality reduction not only can make the model more computationally efficient, but also can help mitigating the risk of overfitting by reducing the complexity of the data, thereby enhancing the model's ability to generalize from the training data to unseen data.

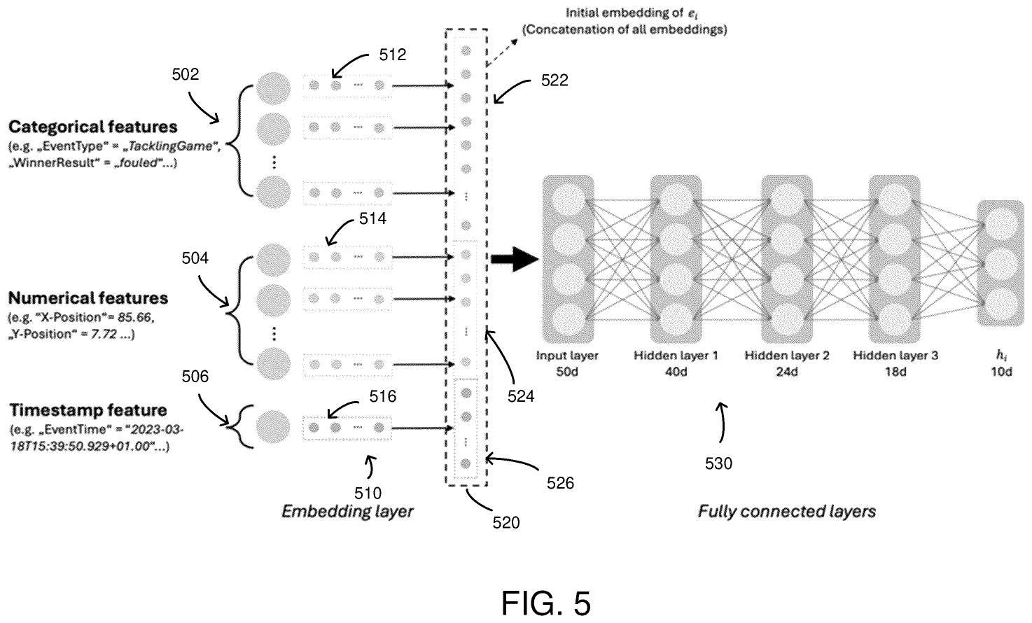

FIG. 5 is a schematic diagram which further illustrates a data embedding process that can be performed by the embedding stack 400 of FIG. 4. As shown, an event eᵢ can have one or more categorical features 502, one or more numerical features 504, and one or more timestamp features. The event eᵢ can be embedded into a composite feature vector 520 using an embedding layer 510, which includes data type-specific encoders, such as one or more entity encoders 512 (for embedding categorical features), one or more positional encoders 514 (for embedding numerical features), and one or more Time2Vec encoders (for embedding timestamp features). In various examples, each feature can have its own data type-specific encoder. For example, if the event eᵢ has two numerical features A and B, then the embedding layer 510 can have two positional encoders, one for embedding feature A and the other for embedding feature B.

The embedding layer 510 operates in an element-wise fashion, that is, each feature is encoded by a respective data type-specific encoder to generate a corresponding feature vector. For example, each categorical feature 502 is encoded by an entity encoder 512 to generate a corresponding categorical feature vector, each numerical feature 504 is encoded by a positional encoder 514 to generate a corresponding numerical feature vector, and each timestamp feature 506 is encoded by a Time2Vec encoder 516 to generate a corresponding timestamp feature vector.

The feature vectors generated for features of different data types can then be concatenated to generate the composite feature vector 520, which represents an initial embedding of the event eᵢ, capturing all its features with mixed data types. In some examples, all categorical feature vectors can be first concatenated to generate a categorical composite feature vector 522, all numerical feature vectors can be first concatenated to generate a numerical composite feature vector 524, and all timestamp feature vectors can be first concatenated to generated a timestamp composite feature 526. Then, the resulting data type-specific composite feature vectors 522, 524, and 526 can be further concatenated to generate the composite feature vector 520. In other examples, concatenation of data type-specific feature vectors can be optional. As a result, the composite feature vector 520 can be formed by juxtaposing feature vectors of various data types.

The composite feature vector 520 can then be processed through a neural network 530 with multiple fully connected layers to generate an event vector hᵢ corresponding to the event eᵢ. The neural network 530 is configured to reduce the dimensionality of the composite feature vector 520 by having an input layer with a dimension equal to the size of the composite feature vector 520 (e.g., 50 nodes if the composite feature vector 520 is of dimension 50), and an output layer with a dimension equal to the desired size of the event vector hᵢ (e.g., 10 nodes if the event vector hᵢ is of dimension 10). This reduction in dimensionality helps to capture the most salient features of the data, thereby improving the efficiency and performance of the model.

The architecture of the neural network 530 is flexible and can be adjusted based on the specific requirements of the sports event analysis. For example, the number of hidden layers in the neural network 530 can vary. While the example in FIG. 5 shows a neural network with three hidden layers, the actual implementation can have more or fewer hidden layers depending on the complexity of the data and the level of abstraction required. Similarly, the number of nodes in each hidden layer can also vary.

### Example Encoder Stack

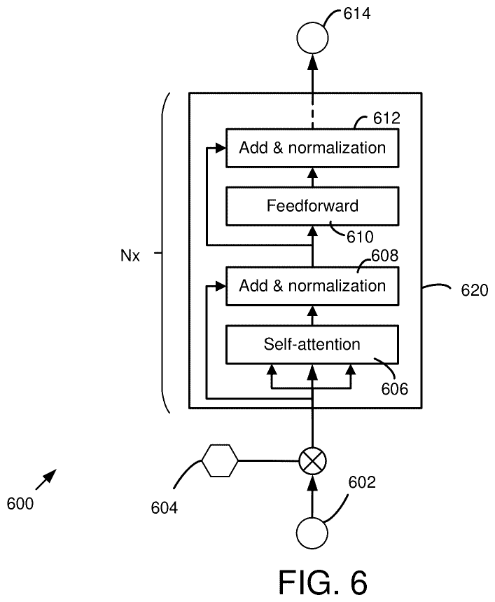

FIG. 6 is a block diagram illustrating an example encoder stack 600, which can be an embodiment of the encoder stack 240 of FIG. 2. The encoder stack 600 functions effectively as a transformer, processing input event vectors 602 (e.g., the event vectors 230 of FIG. 2) and transforming them into encoded event vectors 614 (e.g., the encoded event vectors 250 of FIG. 2) as the output. As described below, the encoded event vectors 614 capture both the individual features of each event and the dependencies between different events in an event sequence, thereby providing more context-rich representation of the events in the event sequence compared to the input event vectors 602.

The encoder stack 600 includes at least one encoder layer 620. In some examples, the encoder stack 600 include multiple stacked or repeated encoder layers 620 (denoted by Nx in FIG. 6). The number of encoded layers 620 in the encoder stack 600 can vary depending on the complexity of the specific task at hand. Generally, a higher “Nx” typically means a deeper ML model, which can capture more complex patterns and dependencies in the data but may require more computational resources for training and inference.

Each encoder layer 620 in the encoder stack 600 can include a self-attention mechanism 606, a first addition and normalization layer 608, a feedforward neural network 610, and a second addition and normalization layer 612.

The self-attention mechanism 606 is configured to weigh the importance of each event in the event sequence when generating the encoded representation for a particular event. This can be achieved, e.g., by applying a set of learned attention weights to the input event vectors 602. The attention weights determine how much each event should contribute to the encoded representation of the current event. Additional details of the self-attention mechanism 606 are described further below.

The first addition and normalization layer 608 can add the output of the self-attention mechanism 606 to the original input (a process known as residual connection), and then normalize the result (e.g., making the features to have zero mean and unit variance). Normalization can help stabilize the learning process and reduce the training time.

The feedforward neural network 610 is configured to apply a sequence of transformations to the output of the first addition and normalization layer 608. These transformations can be the same for each event in the event sequence, while the parameters of the transformations can be shared across all events in the event sequence.

The second addition and normalization layer 612 can apply the same operations as the first addition and normalization layer 608, but to the output of the feedforward neural network 610.

The multiple encoder layers 620 in the encoder stack 600 can operate together to produce the final encoded event vector 614. For example, the input to the first encoder layer 620 is the event vectors 602 initially generated by an embedding stack (e.g., the embedding stack 220 of FIG. 2) based on the original event sequence. The output of each encoder layer 620 (e.g., the output of the second addition and normalization layer 612) is then used as the input to the next encoder layer 620. The output of the final encoder layer 620 is the encoded event vector 614, which is a more context-rich representation of the original event sequence than the initial event vectors 602.

Notably, in traditional language model transformers dealing with text tokens (e.g., each token represents a word or part of a word), positional encoding of input data to the encoder is needed in order to provide sequential order information of the text tokens. This is because the language model transformers, unlike recurrent neural networks, process all tokens in parallel and do not inherently capture the order of text tokens. Without positional encoding, the model would treat a sentence as a collection of words, losing the context provided by the order of words.

However, in this case, positional encoding may be optional before feeding event vectors 602 as input to the encoder stack 600. This is because the positional information of the events in the event sequence is inherently captured by the event vectors 602 themselves. For instance, the timestamps of the events already contain the sequence information of the events. Due to Time2Vec encoding of the timestamp features of the events, each timestamp is embedded into a corresponding event vector, thus effectively capturing the temporal dynamics of the event sequence. This allows the model to understand the order of events and their temporal relationships without the need for additional positional encoding.

In some examples, positional encodings 604 of the events (with the same dimension as the event vectors 602) can be added to the event vectors 602, and their sum is provided as input to the encoder stack 600. The positional encodings 604 encodes the relative or absolute position of the events in the event sequence by using the same or similar encoding functions used by the positional encoder 420 of FIG. 4. Adding positional encodings 604 to the event vector 602 can further enhance the model's ability to capture complex temporal dynamics and dependencies between events, thereby potentially improving the accuracy and robustness of the model's predictions.

### Example Self-Attention Mechanism

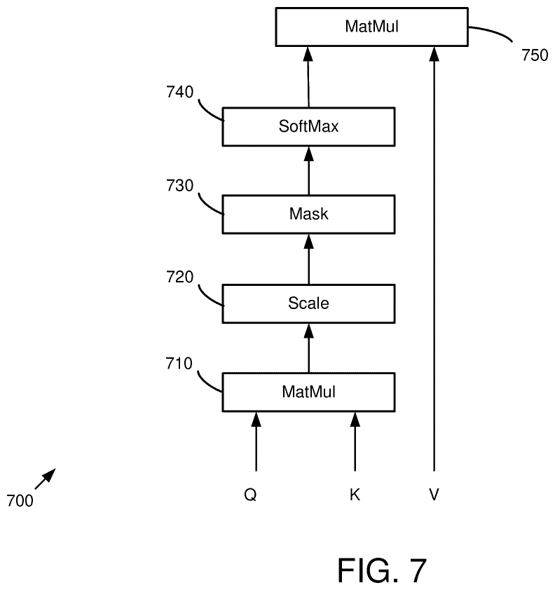

FIG. 7 illustrates an example of a self-attention mechanism 700 that can be implemented in the encoder stack 600 of FIG. 6. The self-attention mechanism 700 is configured to weigh the importance of each event in the event sequence when generating the encoded representation for a particular event.

As shown, the self-attention mechanism 700 operates on queries (Q), keys (K), and values (V), which are matrices generated by applying learned linear transformations to the input event vector (e.g., the event vector 602) corresponding to each event in the event sequence. Each row in these matrices can represent a query, key, or value vector for a specific event. For example, a query vector represents the current event that needs to be encoded, a key vector represents an event in the event sequence, and a value vector represents the actual content of an event. The self-attention mechanism 700 computes attention scores between the query vector and all key vectors, and these scores can be used to weigh the contribution of each value vector to the output. This process can be performed for all query vectors in parallel.

The self-attention mechanism 700 includes a first matrix multiplication, or MatMul unit 710, which receives the query Q and key K as inputs. The first MatMul unit 710 is configured to perform a matrix multiplication operation between Q and the transpose of K, generating a matrix of dot products, which measures the similarity between the current event (represented by the query) and each other event (represented by the key).

The output of the first MatMul unit 710 is then passed to a scaling unit 720, which can scale the output by dividing each element of the matrix dot products by a scaling factor, such as the square root of the dimensions of the queries and keys. This scaling can help stabilize the magnitudes of the dot products, preventing them from becoming too large.

In some examples, the self-attention mechanism 700 can also include a masking unit 730, which can be used to prevent certain positions from attending to subsequent positions. As described further below, the masking unit 730 can be configured to implement causal-masked attention for next events prediction, a task where the future input information (e.g., future events) should not influence the current output.

The output of the masking unit 730 can be passed through a softmax activation layer 740. The softmax activation layer 740 is configured to apply a softmax function to the output of the masking unit 730, generating a distribution of attention weights. This ensures that the weights are positive and sum to one, so they can be interpreted as probabilities.

The self-attention mechanism 700 further includes a second MatMul unit 750 which receives the output of the softmax activation layer 740 and the input value V. The second MatMul unit 750 is configured to perform a matrix multiplication operation to generate the output of the self-attention mechanism 700, which is a weighted sum of the values, with the weights determined by the attention mechanism. As described above, the output of the self-attention mechanism 700 can be used for subsequent processing in the encoder stack (e.g., as an input to the first addition and normalization layer 608 of FIG. 6).

By applying this process to each event in the event sequence, the self-attention mechanism 700 can generate a set of encoded representations that capture the complex dependencies between different events in the event sequence.

### Example Multi-Head Attention

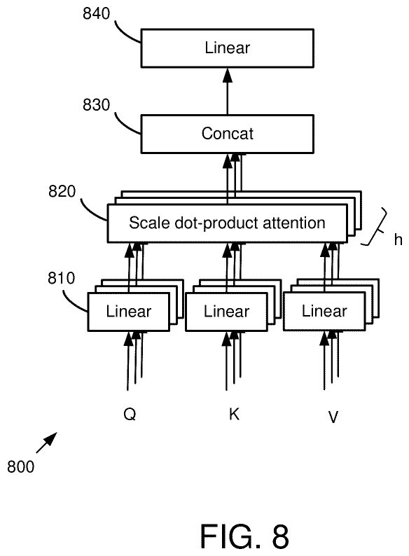

In some examples, the self-attention mechanism described above (e.g., 606 of FIG. 6) can be configured to implement a multi-head attention mechanism. Multi-head attention allows the encoder stack to capture different types of dependencies among events from multiple representation subspaces at different positions in the event sequence. This contrasts with the single-head attention mechanism which only captures dependencies from one representation subspace, potentially missing out on other important relationships among events. FIG. 8 illustrates an example of a multi-head attention mechanism 800 that can be implemented in the encoder stack 600 of FIG. 6.

The multi-head attention mechanism 800 includes three sets of linear activation layers 810 which respectively receive queries (Q), keys (K), and values (V). Each set of linear activation layers 810 can apply a learned linear transformation to its respective input, projecting them into different representation spaces. These transformed Q, K, and V are then passed to a set of scaled dot-product attention layers 820.

More specifically, the queries (Q), keys (K), and values (V) can be linearly projected h times with different, learned linear projections to dₖ, dₖ, and dᵥ dimensions, respectively, where dₖ refers to the dimension of the keys (K) and queries (Q), and dᵥ refers to the dimension of the values (V). These projections are performed h times, resulting in h different sets of queries (Q), keys (K), and values (V). Each set captures different aspects of the input data, allowing the model to attend to different features and relationships in the data.

Each of these attention layers 820 can be configured to apply the scaled dot-product attention mechanism (as described above with reference to FIG. 7) to the transformed Q, K, and V, generating a set of initial outputs. These initial outputs represent the attention outputs for each head in the multi-head attention mechanism 800. Each head is able to attend to different features in the input, thereby capturing different types of dependencies among events.

The initial outputs of the attention layers 820 can then be concatenated by a concatenator 830. This concatenation operation combines the outputs of the multiple attention heads into a single matrix, which captures a more comprehensive representation of the dependencies among events, as it includes information from multiple representation subspaces.

Finally, another linear activation layer 840 can apply a learned linear transformation to the concatenated output, generating the final output of the multi-head attention mechanism 800. This final output is a context-rich representation of the original event sequence, capturing information from different representation subspaces at different positions.

### Example Pre-Training

Refer back to FIG. 2, the ML model 200 can be pre-trained by performing one or more pre-training tasks, as described further below. These pre-training tasks can be self-supervised, meaning that the ML model 200 can leverage its own input data to adjust its parameters. This can be achieved, e.g., by generating classifications for categorical features and predicting values for numerical features (e.g., for regression tasks). Such self-supervised pre-training approach allows the ML model 200 to learn from the inherent structure of the data without the need for manually labeled training data, making it particularly effective for tasks with large amounts of unlabeled data. Once pre-trained, the ML model 200 can be fine-tuned for specific tasks. As described herein, training the ML model 200 includes one or more pre-training tasks. In some examples, training the ML model 200 includes both the pre-training tasks and the fine-tuning.

In some examples, a large amount of event sequences can be generated from a training dataset including sports event data collected during sport games. For example, the entire event sequence of a sport game can be split into multiple sequences by sliding a window over the original event sequence. This window can have a predefined length. In some examples, the sequences can be overlapping. In other examples, the sequences can be non-overlapping depending. Each event sequence can be provided as input to the ML model 200 to generate a corresponding set of encoded event vectors 250. As described above, the encoded event vectors 250 (e.g., O={o₁, o₂, . . . , o_{N}}) generated by the encoder stack 240 can provide a context-rich representation of the original event sequence (e.g., E={e₁, e₂, . . . , e_{N}}, thus they can be used for downstream tasks such as prediction and classification.

Using these large amounts of event sequences, the ML model 200 can be pre-trained in a self-supervised manner. The pre-training involves iteratively updating the model parameters (e.g., model parameters in the embedding stack 220, the encoder stack 240, etc.) by feeding the ML model 200 with different event sequences to improve the accuracy of the predictions in the pre-training tasks. The iterative training process can be performed using methods such as gradient descent or similar optimization algorithms. During each iteration, the model can make predictions based on the current parameters, calculate a loss function that measures the difference between the predictions and the actual values, and then adjust the model parameters to minimize the loss. This process can continue until the model's predictions reach a satisfactory level of accuracy or a predefined stopping criterion is met.

### Example Inference Stack for Predicting Event Features

As described herein, one self-supervised pre-training task is to use the encoded event vectors 250 to predict selected features of the events 210 in the event sequence. Such prediction can be performed by the inference stack 260. Specifically, each encoded event vector oᵢ can be fed into the inference stack 260 to predict selected features of the corresponding event eᵢ. The features to be inferred (e.g., ƒ_{i,j}) can vary depending on types of sports. For instance, for some sports event analysis, the features to be inferred may include the event type, the start and end locations (in x-y coordinates), and the start and end time. For other sports event analysis, a different set of features can be inferred.

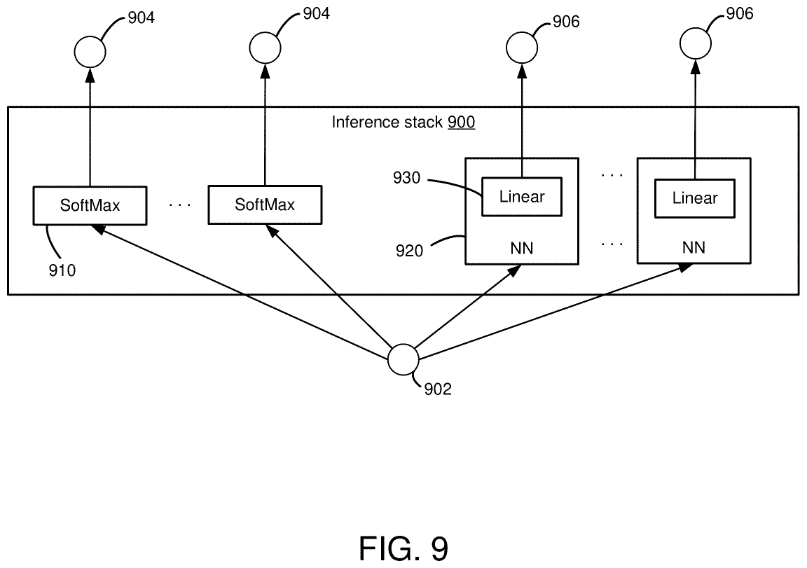

FIG. 9 depicts an example inference stack 900, which can be an embodiment of the inference stack 260 of FIG. 2. As shown, the inference stack 900 can include one or more softmax activation layers 910 (like the softmax activation layer 740 of FIG. 7 but can have different output nodes), and one or more fully connected neural networks 920 (like the fully connected neural network 460 of FIG. 4, but can have different number of hidden layers and/or nodes in each layer). Each fully connected neural network 920 (which can also be referred to as a “dense layer”) can include a respective linear activation layer 930 at its output end. The softmax activation layers 910 can be used to implement classification tasks, whereas the fully connected neural networks 920 can be used to implement regression tasks.

For predicting a categorical feature (e.g., event type), one of the softmax activation layers 910 can receive an encoded event vector 902 as input and generates a predicted categorical value of the feature as the output 904, that is \hat{q}ᵢ=Softmax(oᵢ), where \hat{q}ᵢ∈ [symbol] ^{M} represents the estimated categorical value of the feature in the i-th event, with M being the number of distinct categorical values for the feature (e.g., number of event types). Here, the softmax activation layer 910 is configured to transform a set of numerical inputs (e.g., encoded event vector 902) into probabilities that collectively sum up to one. This transformation facilitates the interpretation of the output as probabilities, thereby aiding in determining the likelihood of each categorical value of the feature in the classification task.

In some examples, multiple softmax activation layers 910 can be used to predict multiple categorical features, e.g., one for predicting event type, one for predicting event outcome, and so on.

For predicting one or more numerical features (e.g., x-y coordinates of locations), the encoded event vector 902 can be provided as an input to a fully connected neural network 920 with a linear activation layer 930, which can be configured to generate predicted values for the one or more numerical features as the output 906. For example, for the tasks of predicting start and end locations of an event, we can have:

$${\hat{l}}_{i , x}^{start} , {\hat{l}}_{i , y}^{start} , {\hat{l}}_{i , x}^{end} , {\hat{l}}_{i , y}^{end} = Dense ( {o}_{i} )$$

$$Here , {\hat{l}}_{i , y}^{start} , {\hat{l}}_{i , y}^{start} , {\hat{l}}_{i , x}^{end} , {\hat{l}}_{i , y}^{end}$$

∈ [symbol] Liu represent the estimated start and end locations (expressed in x and y coordinates) of the event, and Dense(.) represents a dense layer (e.g., a fully connected neural network 920 with a linear activation layer 930 as the output layer of the neural network). In some examples, the linear activation layer can be implemented as an identity function, e.g., ƒ(x)=x, which can be helpful for regression tasks since it allows the model to output values in a numerical range appropriate to the context of the problem.

In some examples, multiple fully connected neural network 920 (each with a linear activation layer 930) can be used to predict multiple sets of numerical features. For example, one fully connected neural network 920 can be used to predict the start and end locations of the event, another fully connected neural network 920 can be used to predict start and end times of the event (e.g., denoted as \hat{t}ᵢ^{start} and \hat{t}ᵢ^{end}, respectively). Notably, the estimated start and end times of the events are represented as numerical values (e.g., representing the time differences between the start and end timestamps of the current event and the timestamp of a starting event such as the first event in the event sequence). These numerical values can be converted back to the timestamp features (e.g., by adding the predicted time differences to the timestamp of the starting event), thereby providing the estimated start and end timestamps of the event.

### Example Prediction of Masked Events

In some examples, self-supervised pre-training the ML model 200 can include the task of predicting one or more randomly masked events in an event sequence using the encoded event vectors 250 generated based on the event sequence.

In some examples, during the pre-training phase, a fraction (e.g, 15% or other percentages) of the events 210 in the event sequence E={e₁, e₂, . . . , e_{N}} are randomly selected and masked. This masking process involves replacing the selected events with a special “mask” symbol, effectively hiding them from the model. The ML model 200 is then tasked with predicting these masked events using the context provided by the unmasked events in the event sequence. The encoded event vectors 250 O={o₁, o₂, . . . , o_{N}} serve as the input to the model for this pre-training task.

The goal of the masked event prediction task is to encourage the ML model 200 to learn to understand the context and dependencies between events in the event sequence. By trying to predict the masked events based on the surrounding unmasked events, the ML model 200 learns to capture both the individual features of each event and the relationships between different events in the event sequence.

### Example Prediction of Next Events

In some examples, self-supervised pre-training the ML model 200 can include predicting one or more subsequent events following an event sequence.

For next events prediction, for each selected event in an event sequence, the ML model 200 can be trained to predict next K events (where K is a predefined integer) by applying a causal-masked attention in the encoder stack 240, that is, when predicting an event, its future events are not considered. This is to enforce that such event can only look at previous events for the prediction.

In some examples, the causal-masked attention can be implemented by utilizing the masking unit 730 depicted in FIG. 7. As described above, the masking unit 730 can be configured to prevent certain positions from attending to subsequent positions, effectively blocking the influence of future events on the current output. This can be achieved by masking future positions (e.g., setting them to −∞) in the self-attention calculation. In other words, to predict an event, the masking unit 730 will only consider previous events by applying a mask to the self-attention mechanism 700 that nullifies the attention scores corresponding to future events.

### Example Loss Function

As described above, a loss function can be calculated during iterative and self-supervised pre-training of the ML model 200, based on which the model parameters can be iteratively updated.

The loss function can be defined differently based on the pre-training tasks and what event features are of interests. One example loss function can be defined as follows:

$${\sum }_{{e}_{i}} ( - {\sum }_{m = 1}^{M} {q}_{i} \cdot log {\hat{q}}_{i} ) + {λ}_{l} \cdot {\sum }_{{e}_{i}} [ {( {l}_{i , x}^{start} - {\hat{l}}_{i , x}^{start} )}^{2} + ( {l}_{i , y}^{start} - {\hat{l}}_{i , y}^{start} ) + {( {l}_{i , x}^{end} - {\hat{l}}_{i , x}^{end} )}^{2} + {( {l}_{i , y}^{end} - {\hat{l}}_{i , y}^{end} )}^{2} ] + {λ}_{t} \cdot {\sum }_{{e}_{i}} [ {( {t}_{i}^{start} - {\hat{t}}_{i}^{start} )}^{2} + {( {t}_{i}^{end} - {\hat{t}}_{i}^{end} )}^{2} ]$$

In this example, the loss function is a combination of three components, each being represented as a sum (Σ) over one or more features of a specific data type for a selected group of events. The first component measures a cross-entropy loss for a categorical feature (e.g., event type), which can have M distinct categorical values, where qᵢ represents the true categorical value of the feature and \hat{q}ᵢ represents the estimated categorical value of the feature for event eᵢ. The summation in the first component is calculated for all events in the selected group of events. The second component is weighted squared errors for estimated start and end locations of the event eᵢ (numerical features) expressed in both x and y coordinates (e.g.,

$${l}_{i , x}^{start} and {\hat{l}}_{i , x}^{start}$$

respectively represent the true and estimated start x-coordinates of event eᵢ, and so on). The summation in the second component is also calculated for all events in the selected group of events. The third component is weighted squared errors for estimated start and end times (timestamp features expressed in time differences, thus numerical values, e.g.,

$${t}_{i}^{start} and {\hat{t}}_{i}^{start}$$

respectively represent the true and estimated start time of the event eᵢ, and so on). Likewise, the summation in the third component is calculated for all events in the selected group of events. Here, λₗ and λₜ are predefined weights for the second and third components, respectively. In some examples, another weight can be added to the first component.

It should be understood that the loss function described above is merely one example, and the loss function can be defined to include different components. For example, the loss function can include multiple cross-entropy loss components (weighted or unweighted) corresponding to multiple categorical features. Or the loss function may not include any cross-entropy loss functions (e.g., if the prediction of categorical features is not of interest). As another example, the loss function can include zero, one, or more than two components representing weighted squared errors of numerical features.

For the pre-training task of predicting selected features of the events, the loss function can be defined to include measurement of loss/error of only those selected features. For example, if the selected features for prediction include event type, start and end locations, and start and end time, the loss function can include all three components described above. On the other hand, if start and end time are not the selected features, then the loss function may only include the first and second components. In some examples, the selected group of events (that is, the scope of the summation) can include all events in the event sequence. In other examples, the selected group of events can include only a subset of the events in the event group.

For the pre-training task of predicting masked events, the selected group of events includes only those masked events. The features measured in the loss function can be predefined (e.g., all event features or a selected subset of the features).

For the pre-training task of predicting the next K events, the selected group of events includes only those K events. Similarly, the features measured in the loss function can be predefined (e.g., all event features or a selected subset of the features).

### Example Model Fine Tuning

After the pre-training is completed, the ML model 200 (excluding the inference stack 260) can be fine-tuned for more specific inference tasks. More specifically, the inference stack 260 in the pre-trained ML model 200 can be replaced with a different inference stack to fine-tune the ML model 200 for various downstream tasks.

For example, the pre-trained ML model 200 can be fine-tuned to predict the outcome of a sports event sequence. In this case, different events in the event sequence (which can have mixed data types) can be embedded into corresponding event vectors by the embedding stack 220. The encoder stack 240 then transforms the event vectors, which represent the sequence of events in a sports game, into encoded event vectors. As described above, these encoded vectors capture the latent relationships and context within the event sequence, providing a high-level semantic understanding of the game. A dedicated inference stack, which can have a similar structure but is different from the inference stack 260 used in the pre-training, can then be used to predict the outcome of the event sequence based on these encoded event vectors.

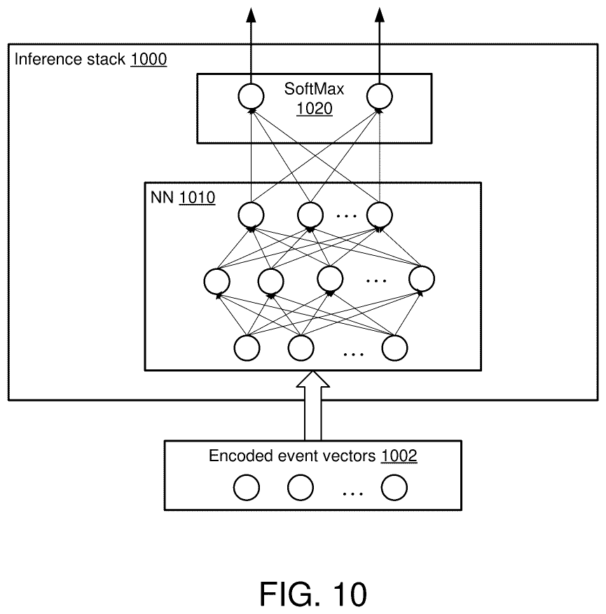

As an example, FIG. 10 illustrates an inference stack 1000 which includes a fully connected neural network 1010 and a softmax activation layer 1020. For each event sequence including a plurality of events, a plurality of encoded event vectors 1002 can be generated by the pre-trained ML model, as described above. The encoded event vectors 1002 can be fed to the input layer of the neural network 1010, and the output layer of the neural network 1010 can be connected to the softmax activation layer 1020 for generating probability distributions over or predicting potential outcomes of the event sequence. The neural network 1010 can have different number of hidden layers and/or nodes in each layer than the neural networks 920 of FIG. 9 and the neural network 460 of FIG. 4. The softmax activation layer 1020 can have different output nodes (e.g., two nodes representing a binary event outcome is shown in the depicted example) than the softmax activation layers 910 of FIG. 9 and the softmax activation layer 740 of FIG. 7.

As a more specific example, an event sequence in a soccer game could include events like passes, shots, dribbles, and corner kicks, each represented as an event vector. After fine-tuning, the ML model 200 can predict whether a goal will be scored or not following this event sequence. The inference stack 1000 in this case can be specifically trained to make goal and no-goal predictions based on a large cohort of event sequences collected during one or more soccer games. This fine-tuning process, which is a form of supervised training, involves using labeled data, where the correct outcomes (e.g., goal or no-goal) are known for each event sequence. The model learns from this data, adjusting model parameters (e.g., weights of the neural network 1010, etc.) to minimize the difference between its predictions and the actual outcomes. After the fine tuning, the ML model 200 can be deployed to predict similar event sequences in the future, as described above with reference to FIG. 1.

In addition to predicting goals and no-goals, the inference stack 1000 can be further configured to generate a broader range of analytical results. For example, the inference stack 1000 can be trained to calculate the contribution of each event in an event sequence to an event outcome. As another example, the inference stack 1000 can be fine-tuned to analyze the impact of specific players on the game (e.g., by examining the events associated with a particular player, the ML model 200 can quantify their influence on the game's outcome). Other specific downstream tasks can be implemented by fine-tuning the ML model 200.

In some examples, the fine-tuning limits the parameter adjustment to the inference stack 1000. In other words, the lower layers (like the embedding stack 220 and encoder stack 240) of the ML model 200 which have been pre-trained on a large dataset can be “frozen” or kept constant, during fine-tuning. This is because these layers often capture general features that are useful across many tasks and fine-tuning them might lead to overfitting on the specific task at hand. Alternatively, the fine-tuning can adjust the parameters of other layers of the model, such as the embedding stack 220 and/or the encoder stack 240. In such cases, the parameters of the inference stack 1000 can be adjusted more extensively than the lower stacks as the inference stack 1000 is more responsible for making the final predictions and need to be adapted to the specific task.

### Example Advantages

The technologies described herein offer several technical advantages over conventional sports event data analysis techniques.

First, the use of a ML model for sports event data analysis allows for the capture of high-level latent patterns in the sports event data. This represents a significant improvement over traditional methods that rely on raw feature representations, which often fail to capture these intricate patterns. By learning these latent patterns, the ML model can provide a more nuanced understanding of the game dynamics and player performance.

Another technical advantage of the disclosed technologies is the ability of the ML model to accurately reflect the diverse impacts of different events on the game outcome. Unlike conventional approaches that assume all previous events have equal impact on the current event, the ML model, through the self-attention mechanism, recognizes that the impact of an event can be influenced by a variety of factors, including the sequence and context of preceding events. This leads to a more accurate quantification of event impacts, enhancing the quality of the analysis.

A further technical advantage of the disclosed technologies lies in the ability to embed events with mixed data types. This is particularly beneficial in sports event data analysis, where events can encompass a wide range of data types (e.g., categorical, numerical, timestamps, etc.). By embedding these diverse data types into a unified representation, the ML model can effectively capture the interrelationships and dependencies among different types of events. This leads to a more comprehensive and holistic understanding of the game dynamics. Moreover, by embedding timestamps of the events, the ML model can capture the temporal dynamics of the events in lieu of, or in addition to, positional encodings of the event sequence, thereby enhancing the model's ability to accurately predict outcomes based on the sequence and timing of events.

Furthermore, the pre-trained ML model is adaptable and can be fine-tuned for various specific inference tasks. This adaptability extends the utility of the ML model beyond a single type of sports event data analysis.

### Example Computing Systems

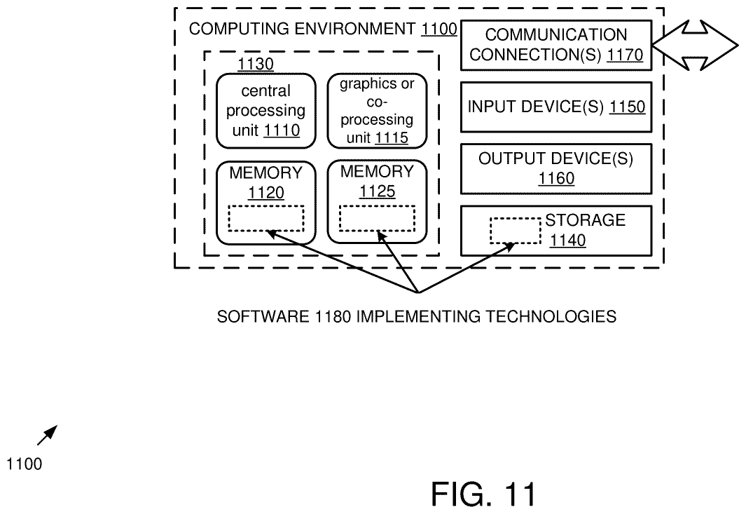

FIG. 11 depicts an example of a suitable computing system 1100 in which the described innovations can be implemented. The computing system 1100 is not intended to suggest any limitation as to scope of use or functionality of the present disclosure, as the innovations can be implemented in diverse computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 can execute computer-executable instructions, such as for implementing the features described in the examples herein (e.g., the method 300). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 11 shows a central processing unit 1110 as well as a graphics processing unit or co-processing unit 1115. The tangible memory 1120, 1125 can be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 can store software 1180 implementing one or more innovations described herein, in the form of computer-executable instructions suitable for execution by the processing unit(s) 1110, 1115.

A computing system 1100 can have additional features. For example, the computing system 1100 can include storage 1140, one or more input devices 1150, one or more output devices 1160, and one or more communication connections 1170, including input devices, output devices, and communication connections for interacting with a user. An interconnection mechanism (not shown) such as a bus, controller, or network can interconnect the components of the computing system 1100. Typically, operating system software (not shown) can provide an operating environment for other software executing in the computing system 1100, and coordinate activities of the components of the computing system 1100.

The tangible storage 1140 can be removable or non-removable, and includes magnetic disks, magnetic tapes or cassettes, CD-ROMs, DVDs, or any other medium which can be used to store information in a non-transitory way and which can be accessed within the computing system 1100. The storage 1140 can store instructions for the software implementing one or more innovations described herein.

The input device(s) 1150 can be an input device such as a keyboard, mouse, pen, or trackball, a voice input device, a scanning device, touch device (e.g., touchpad, display, or the like) or another device that provides input to the computing system 1100. The output device(s) 1160 can be a display, printer, speaker, CD-writer, or another device that provides output from the computing system 1100.

The communication connection(s) 1170 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

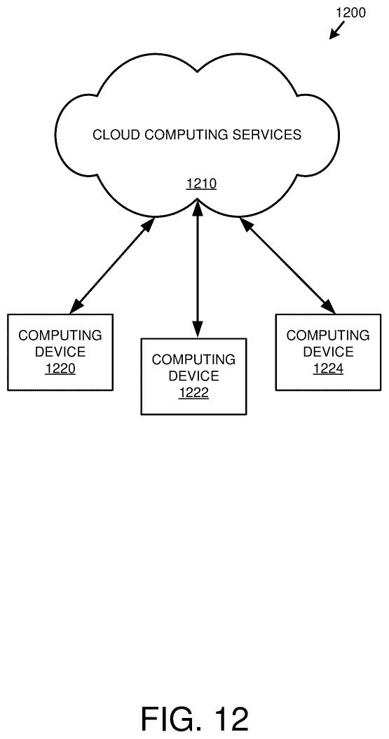

FIG. 12 depicts an example cloud computing environment 1200 in which the described technologies can be implemented, including, e.g., the system 100 and other systems herein. The cloud computing environment 1200 can include cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 can be utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (SaaS), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### EXAMPLE CLAUSES

Any of the following example clauses can be implemented.

Clause 1. A computing system, comprising: memory; one or more hardware processors coupled to the memory; and one or more non-transitory computer readable storage media storing instructions that, when loaded into the memory, cause the one or more hardware processors to perform operations comprising: receiving a sport event sequence comprising a plurality of events ordered sequentially, wherein an event comprises a plurality of features with mixed data types; embedding the plurality of events into a plurality of event vectors using an embedding stack, wherein the embedding stack applies different embedding schemes for features with different data types; transforming the plurality of event vectors into a plurality of encoded event vectors using an encoder stack, wherein the encoder stack comprises at least one encoder layer, wherein the at least one encoder layer is configured to apply a self-attention mechanism to the plurality of event vectors; and training a machine learning model for predicting one or more subsequent events following a new sport event sequence, wherein the training comprises adjusting parameters of the embedding stack and the encoder stack based at least in part on the plurality of encoded event vectors.

Clause 2. The computing system of clause 1, wherein for a selected event, the embedding stack is configured to applies a first embedding scheme to generate one or more first feature vectors based on a first subset of features having a categorical data type, and applies a second embedding scheme to generate one or more second feature vectors based on a second subset of features having a numerical data type.

Clause 3. The computing system of clause 2, wherein the embedding stack is configured to concatenate the one or more first feature vectors and the one or more second feature vectors into a composite feature vector for the selected event.

Clause 4. The computing system of clause 3, wherein the embedding stack further comprises a fully connected neural network configured to convert the composite feature vector into an event vector for the selected event, wherein the event vector has a lower dimension than the composite feature vector.

Clause 5. The computing system of clause 1, wherein training the machine learning model comprises predicting at least some of the features of a selected event based on the encoded event vector corresponding to the selected event using a first inference stack.

Clause 6. The computing system of clause 5, wherein the first inference stack comprises a first softmax activation layer configured to predict one or more features with a categorical data type and a first fully connected neural network with a linear activation layer configured to predict one or more features with a numerical data type.

Clause 7. The computing system of clause 1, wherein training the machine learning model comprises predicting one or more randomly masked events in the sport event sequence.

Clause 8. The computing system of clause 1, wherein training the machine learning model comprises predicting one or more subsequent events following the sport event sequence.

Clause 9. The computing system of clause 1, wherein training the machine learning model comprises computing a loss function, wherein the loss function is a combination of a cross-entropy loss for one or more features with a categorical data type and weighted squared errors for one or more features with a numerical data type.

Clause 10. The computing system of clause 5, wherein training the machine learning model comprises predicting an event outcome following the sport event sequence based on the plurality of encoded event vectors, wherein predicting the event outcome uses a second inference stack comprising a second fully connected neural network and a second softmax activation layer.

Clause 11. A computer-implemented method, comprising: receiving a sport event sequence comprising a plurality of events ordered sequentially, wherein an event comprises a plurality of features with mixed data types; embedding the plurality of events into a plurality of event vectors using an embedding stack, wherein the embedding stack applies different embedding schemes for features with different data types; transforming the plurality of event vectors into a plurality of encoded event vectors using an encoder stack, wherein the encoder stack comprises at least one encoder layer, wherein the at least one encoder layer is configured to apply a self-attention mechanism to the plurality of event vectors; and training a machine learning model for predicting one or more subsequent events following a new sport event sequence, wherein the training comprises adjusting parameters of the embedding stack and the encoder stack based at least in part on the plurality of encoded event vectors.

Clause 12. The method of clause 11, wherein for a selected event, the embedding stack is configured to applies a first embedding scheme to generate one or more first feature vectors based on a first subset of features having a categorical data type, and applies a second embedding scheme to generate one or more second feature vectors based on a second subset of features having a numerical data type.

Clause 13. The method of clause 12, wherein the embedding stack is configured to concatenate the one or more first feature vectors and the one or more second feature vectors into a composite feature vector for the selected event.

Clause 14. The method of clause 13, wherein the embedding stack further comprises a fully connected neural network configured to convert the composite feature vector into an event vector for the selected event, wherein the event vector has a lower dimension than the composite feature vector.

Clause 15. The method of clause 11, wherein training the machine learning model comprises predicting at least some of the features of a selected event based on the encoded event vector corresponding to the selected event using a first inference stack.

Clause 16. The method of clause 15, wherein the first inference stack comprises a first softmax activation layer configured to predict one or more features with a categorical data type and a first fully connected neural network with a linear activation layer configured to predict one or more features with a numerical data type.

Clause 17. The method of clause 11, wherein training the machine learning model comprises predicting one or more randomly masked events in the sport event sequence.

Clause 18. The method of clause 11, wherein training the machine learning model comprises predicting one or more subsequent events following the sport event sequence.

Clause 19. The method of clause 11, wherein training the machine learning model comprises computing a loss function, wherein the loss function is a combination of a cross-entropy loss for one or more features with a categorical data type and weighted squared errors for one or more features with a numerical data type.

Clause 20. One or more non-transitory computer-readable media having encoded thereon computer-executable instructions causing one or more processors to perform a method, the method comprising: receiving a sport event sequence comprising a plurality of events ordered sequentially, wherein an event comprises a plurality of features with mixed data types; embedding the plurality of events into a plurality of event vectors using an embedding stack, wherein the embedding stack applies different embedding schemes for features with different data types; transforming the plurality of event vectors into a plurality of encoded event vectors using an encoder stack, wherein the encoder stack comprises at least one encoder layer, wherein the at least one encoder layer is configured to apply a self-attention mechanism to the plurality of event vectors; and training a machine learning model for predicting one or more subsequent events following a new sport event sequence, wherein the training comprises adjusting parameters of the embedding stack and the encoder stack based at least in part on the plurality of encoded event vectors.

### Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system, comprising:
memory;
one or more hardware processors coupled to the memory; and
one or more non-transitory computer readable storage media storing instructions that, when loaded into the memory, cause the one or more hardware processors to perform operations comprising:
receiving a sport event sequence comprising a plurality of events ordered sequentially, wherein an event comprises a plurality of features with mixed data types;
embedding the plurality of events into a plurality of event vectors using an embedding stack, wherein the embedding stack applies different embedding schemes for features with different data types;
transforming the plurality of event vectors into a plurality of encoded event vectors using an encoder stack, wherein the encoder stack comprises at least one encoder layer, wherein the at least one encoder layer is configured to apply a self-attention mechanism to the plurality of event vectors; and
training a machine learning model for predicting one or more subsequent events following a new sport event sequence, wherein the training comprises adjusting parameters of the embedding stack and the encoder stack based at least in part on the plurality of encoded event vectors.

2. The computing system of claim 1, wherein for a selected event, the embedding stack is configured to applies a first embedding scheme to generate one or more first feature vectors based on a first subset of features having a categorical data type, and applies a second embedding scheme to generate one or more second feature vectors based on a second subset of features having a numerical data type.

3. The computing system of claim 2, wherein the embedding stack is configured to concatenate the one or more first feature vectors and the one or more second feature vectors into a composite feature vector for the selected event.

4. The computing system of claim 3, wherein the embedding stack further comprises a fully connected neural network configured to convert the composite feature vector into an event vector for the selected event, wherein the event vector has a lower dimension than the composite feature vector.

5. The computing system of claim 1, wherein training the machine learning model comprises predicting at least some of the features of a selected event based on the encoded event vector corresponding to the selected event using a first inference stack.

6. The computing system of claim 5, wherein the first inference stack comprises a first softmax activation layer configured to predict one or more features with a categorical data type and a first fully connected neural network with a linear activation layer configured to predict one or more features with a numerical data type.

7. The computing system of claim 1, wherein training the machine learning model comprises predicting one or more randomly masked events in the sport event sequence.

8. The computing system of claim 1, wherein training the machine learning model comprises predicting one or more subsequent events following the sport event sequence.

9. The computing system of claim 1, wherein training the machine learning model comprises computing a loss function, wherein the loss function is a combination of a cross-entropy loss for one or more features with a categorical data type and weighted squared errors for one or more features with a numerical data type.

10. The computing system of claim 5, wherein training the machine learning model comprises predicting an event outcome following the sport event sequence based on the plurality of encoded event vectors, wherein predicting the event outcome uses a second inference stack comprising a second fully connected neural network and a second softmax activation layer.

11. A computer-implemented method, comprising:
receiving a sport event sequence comprising a plurality of events ordered sequentially, wherein an event comprises a plurality of features with mixed data types;
embedding the plurality of events into a plurality of event vectors using an embedding stack, wherein the embedding stack applies different embedding schemes for features with different data types;
transforming the plurality of event vectors into a plurality of encoded event vectors using an encoder stack, wherein the encoder stack comprises at least one encoder layer, wherein the at least one encoder layer is configured to apply a self-attention mechanism to the plurality of event vectors; and
training a machine learning model for predicting one or more subsequent events following a new sport event sequence, wherein the training comprises adjusting parameters of the embedding stack and the encoder stack based at least in part on the plurality of encoded event vectors.

12. The method of claim 11, wherein for a selected event, the embedding stack is configured to applies a first embedding scheme to generate one or more first feature vectors based on a first subset of features having a categorical data type, and applies a second embedding scheme to generate one or more second feature vectors based on a second subset of features having a numerical data type.

13. The method of claim 12, wherein the embedding stack is configured to concatenate the one or more first feature vectors and the one or more second feature vectors into a composite feature vector for the selected event.

14. The method of claim 13, wherein the embedding stack further comprises a fully connected neural network configured to convert the composite feature vector into an event vector for the selected event, wherein the event vector has a lower dimension than the composite feature vector.

15. The method of claim 11, wherein training the machine learning model comprises predicting at least some of the features of a selected event based on the encoded event vector corresponding to the selected event using a first inference stack.

16. The method of claim 15, wherein the first inference stack comprises a first softmax activation layer configured to predict one or more features with a categorical data type and a first fully connected neural network with a linear activation layer configured to predict one or more features with a numerical data type.

17. The method of claim 11, wherein training the machine learning model comprises predicting one or more randomly masked events in the sport event sequence.

18. The method of claim 11, wherein training the machine learning model comprises predicting one or more subsequent events following the sport event sequence.

19. The method of claim 11, wherein training the machine learning model comprises computing a loss function, wherein the loss function is a combination of a cross-entropy loss for one or more features with a categorical data type and weighted squared errors for one or more features with a numerical data type.

20. One or more non-transitory computer-readable media having encoded thereon computer-executable instructions causing one or more processors to perform a method, the method comprising:
receiving a sport event sequence comprising a plurality of events ordered sequentially, wherein an event comprises a plurality of features with mixed data types;
embedding the plurality of events into a plurality of event vectors using an embedding stack, wherein the embedding stack applies different embedding schemes for features with different data types;
transforming the plurality of event vectors into a plurality of encoded event vectors using an encoder stack, wherein the encoder stack comprises at least one encoder layer, wherein the at least one encoder layer is configured to apply a self-attention mechanism to the plurality of event vectors; and
training a machine learning model for predicting one or more subsequent events following a new sport event sequence, wherein the training comprises adjusting parameters of the embedding stack and the encoder stack based at least in part on the plurality of encoded event vectors.
